(19) United States
(12) Patent Application Publication
(10) Pub. No.: US 2018/0166047 A1
(43) Pub. Date: Jun. 14, 2018

(54) ELECTRONIC CONTROL DEVICE

(71) Applicant: DENSO CORPORATION, Kariya-city (JP)

(72) Inventor: Narihito YAMAZATO, Kariya-city (JP)

(21) Appl. No.: 15/826,774

(22) Filed: Nov. 30, 2017

(30) Foreign Application Priority Data
Dec. 9, 2016 (JP) 2016-239352

(51) Int. Cl. G09G 5/38; G02B 27/01; B60R 1/00

(52) U.S. Cl. CPC G09G 5/38; G02B 27/0101; B60R 1/00; G09G 2380/10; G09G 2340/0464; B60R 2300/8046; G02B 2027/0138; G02B 2027/014; B60R 2300/105; B60R 2300/205; G09G 2354/00

(57) ABSTRACT

Positioning and displaying information at a driver-desired position for driver's convenience and for preventing the misperception of directional-based images by the driver to maintain driving safety is provided by an electronic control device including a display controller for controlling a display unit to display information including a vehicle environment image captured by an on-board camera; and a restriction provider for providing restrictions on a driver-customizable display position of the information on the display unit.

### CROSS REFERENCE TO RELATED APPLICATION

The present application is based on and claims the benefit of priority of Japanese Patent Application No. 2016-239352, filed on Dec. 9, 2016, the disclosure of which is incorporated herein by reference.

### TECHNICAL FIELD

The present disclosure generally relates to an electronic control device/unit used in a vehicle and other places.

### BACKGROUND INFORMATION

Conventionally, an information display device for displaying information in a vehicle has been proposed, for example, as disclosed by a patent document 1 (i.e., Japanese Patent Laid-Open No. H04-368241), that is a system for displaying information such as an image of vehicle surroundings captured by an on-board camera.

In such a system, the viewing angle of the display has no effect on a driver's view of the information (i.e., the image(s)). That is, the driver's position relative to the display does not affect how the driver sees the information on display device. However, one drawback of such a display is the fixed display position of the information on the display, as well as the fixed position of the display device itself. That is, the information on the display and the display device itself cannot be moved or repositioned to a driver-desired position.

Displaying information on a windshield or spread out over an instrument panel (i.e., utilizing an entire instrument panel as a display device) may provide a larger information display area, which allows the driver to “customize,” adjust, and rearrange the display position of the vehicle information based on the driver's preference. In such cases however, the customized positioning of the vehicle information may cause a false recognition or perception by the driver if, for example, the display position of vehicle information showing an image captured by a camera on the right side of the vehicle is displayed on a left side of the display device. Such a reverse positioning of a direction-specific image may affect operation of the vehicle by altering a driver's perception.

### SUMMARY

It is an object of the present disclosure to provide an electronic control device to improve a driver's viewability of display information for ease of viewing in a position customizable by the driver and for increasing vehicle safety by limiting the false perception of the displayed vehicle information by the driver.

In an aspect of the present disclosure, the electronic control device includes a display controller configured to control a display device for displaying vehicle information that includes images of a vehicle environment captured by an on-board camera; and a display restriction control configured to restrict a display position of the vehicle information.

For example, non-position specific or “non-directional” vehicle information, that is, information not likely to be misperceived based on its display position, may be freely positioned on a display device without restricting the display position of the information. As such, non-position specific information is unrestricted and may be moved to a driver-desired position or to an easily-viewable position. On the other hand, “directional” information, or position-specific information, e.g., vehicle information corresponding to images from the right side or the left side of the vehicle, may be prone to misperception by the driver if such vehicle information is reversely displayed, that is, displayed in a position that is opposite of, or reversed from, the position on or near the vehicle where the information is obtained. As such, the display position of “directional,” position-specific, vehicle information on a display device may be restricted to prevent or limit a user from moving, customizing, or otherwise repositioning the display location/position of the position-specific vehicle information to certain areas on the display device. By limiting display position restrictions to only “directional” information, improved viewablilty of display information may be obtained by allowing a driver to reposition and move display information to a driver-desired position, while limiting the display positioning of perception-critical display information. That is, the display position restriction scheme provides an increased convenience to the driver while also maintaining driver safety.

### BRIEF DESCRIPTION OF THE DRAWINGS

Objects, features, and advantages of the present disclosure will become more apparent from the following detailed description made with reference to the accompanying drawings, in which:

FIG. 1 illustrates a block diagram of a system with an electronic control device;

FIG. 2 illustrates a profile selection screen;

FIG. 3 illustrates a display profile;

FIG. 4 illustrates a customization screen;

FIG. 5 illustrates a customization screen;

FIG. 6 illustrates an image display on a windshield;

FIG. 7 illustrates an image display on a windshield;

FIG. 8 is a flowchart of a process performed by an electronic control device;

FIG. 9 illustrates a customization screen;

FIG. 10 illustrates an image display on a windshield;

FIG. 11 illustrates a customization screen;

FIG. 12 illustrates an image display on a windshield;

FIG. 13 illustrates a customization screen;

FIG. 14 illustrates a customization screen; and

FIG. 15 illustrates a customization screen.

### DETAILED DESCRIPTION

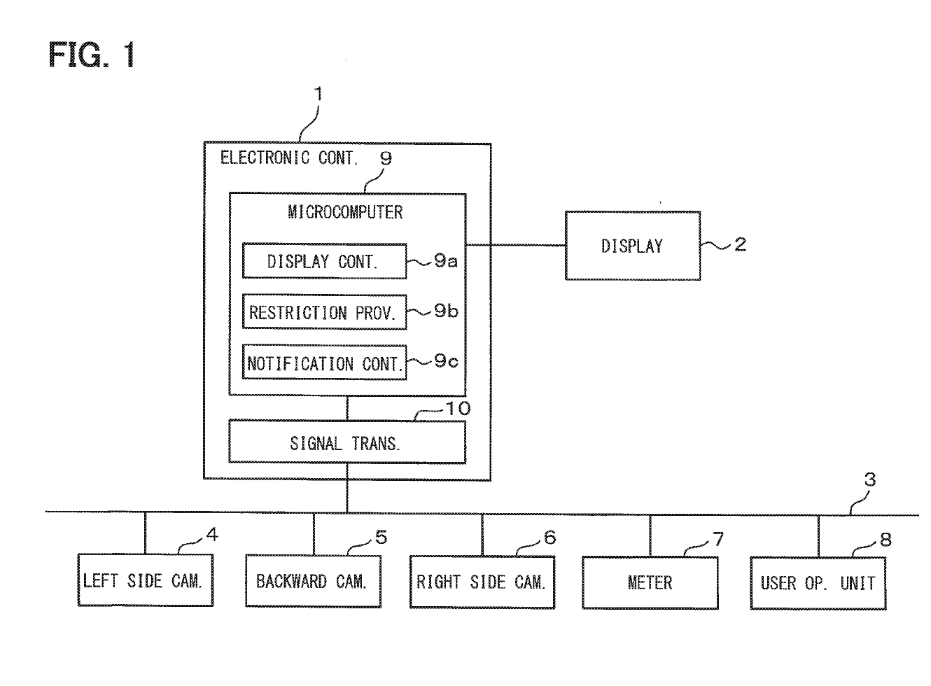

With reference to FIG. 1, an electronic control device 1 is a device that controls the display of information showing an image of a vehicle environment or surroundings. A display device 2 may be directly connected, and other devices such as a left side camera 4 (i.e., one of the on-board cameras), a backward camera 5 (i.e., one of the on-board cameras), a right side camera 6 (i.e., one of the on-board cameras), a meter device 7, and a user operation unit 8 may be connected via a bus 3. The bus 3 may operate following protocols and standards such as CAN, LIN, CXPI, FlexRay, MOST, and the like.

The electronic control device 1 has a microcomputer 9 and a signal transceiver 10. The microcomputer 9 has CPU, ROM, RAM, and like components. The CPU may execute a control program stored in ROM for controlling an operation of the electronic control device 1. The signal transceiver 10 controls transmission and reception of various signals to and from the bus 3.

The display device 2 is a “windshield,” heads-up display (HUD)-type display. For example, when a display instruction signal is input to the electronic control device 1 the display device 2 projects an image for display on the front window, i.e., the windshield of the vehicle. The left side camera 4 on a left-hand side of the vehicle captures/streams a left side view of the vehicle, and transmits a video signal that may include a captured or real-time image of the left side view to the electronic control device 1. The backward camera 5 captures a rear view, i.e., a backward facing view, of the vehicle, and transmits a video signal including an image of the rear view to the electronic control device 1. The right side camera 6 on a right-hand side of the vehicle captures/streams a right side view of the vehicle, and transmits a video signal that may include a captured or real-time image of the right side view to the electronic control device 1. The meter device 7 transmits a vehicle speed signal including a vehicle speed and a time signal including time to the electronic control device 1.

The user operation unit 8 is provided as a display device having a touch screen/panel or the like to provide a touch interface for operation via a finger touch of the user/driver. When an operation of the driver on the touch panel is detected, the detected operation is transmitted as an operation detection signal to the electronic control device 1.

When the user operation unit 8 receives a screen-display signal from the electronic control device 1, the user operation unit 8 displays a screen image based on the received screen-display signal, and, when the user operation unit 8 receives a notification signal from the electronic control device 1, the user operation unit 8 displays the notification information based on the received notification signal.

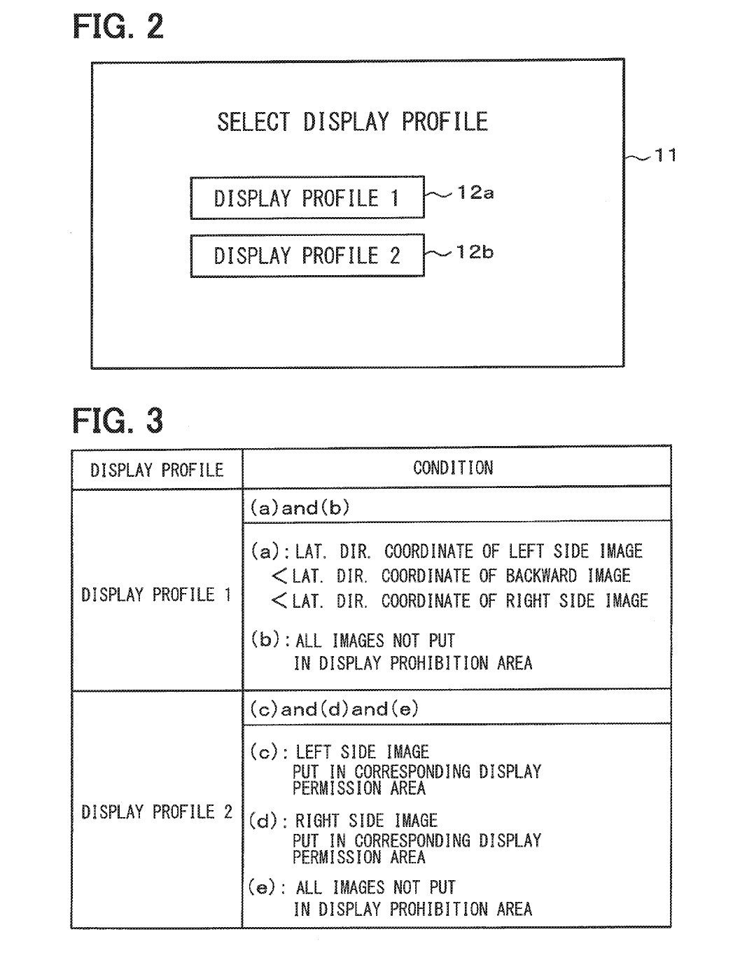

When the screen-display signal that instructs the profile selection screen to be displayed is received from the electronic control device 1, the user operation unit 8 displays a profile selection screen 11, as shown in FIG. 2. When the profile selection screen 11 is displayed on the user operation unit 8, the driver is enabled to select one of display profiles displayed on the profile selection screen 11. As illustrated in FIG. 2, a key (i.e., a touch screen selection button) for “display profile 1” 12a and a key for “display profile 2” 12b are displayed and the driver can select either the key 12a or the key 12b.

With reference to FIG. 3, a “display profile” may include for example, one or more regulations and restrictions that may restrict a display position of a vehicle information image on the windshield. The regulations/restrictions may be defined as a set of conditions, i.e., as one or more conditions.

For example, a display profile 1 may be defined using Boolean operators such as “AND” (i.e., a combination) of the following two conditions (a) and (b). The lateral direction coordinate used in the following conditions is defined, for example, as a left-to-right horizontal axis, such that a value on the horizontal axis increases from left to right. In this example, the left and the right of the horizontal axis (i.e., a lateral direction axis) are mapped to the left side and the right side of the front window relative to a forward facing view of the driver of the vehicle. In other words, a leftward direction of the horizontal axis is a negative or minus direction of the coordinate, and a rightward direction of the horizontal axis is a positive or plus direction of the coordinate, and the leftward direction and the rightward direction may collectively be designated as a lateral direction. The coordinate along the horizontal axis may thus be designated as a lateral direction coordinate. The restriction conditions may be based on the lateral direction coordinates.
Condition (a): Lateral direction coordinate of the left side image<Lateral direction coordinate of the rearview image<Lateral direction coordinate of the right side image.
   In other words, in Condition (a), the lateral direction coordinate of the left side image is less than the lateral direction coordinate of the rearview image, and both of the lateral direction coordinates of the left side image and the rearview image are less than the lateral direction coordinate of the right side image.
Condition (b): All images not put in a display prohibition area.

Further, a display profile 2 may be defined by the AND operator (i.e., a combination) of the following three conditions (c) to (e).
Condition (c): The left side image put in a corresponding display permission area.
Condition (d): The right side image exists in a corresponding display permission area.
Condition (e): All images not put in a display prohibition area.

The determination regarding the conditions (a) to (e) may be made for all the coordinates of an image, or may be made only for a certain coordinate of the image (e.g., only for a center position coordinate of the image). Upon receiving a driver's input of profile selection by a touching on one of the displayed keys, the user operation unit 8 transmits an operation detection signal indicative of a display profile selected by the driver to the electronic control device 1. The electronic control device 1 transmits, upon receiving the operation detection signal from the user operation unit 8, the screen-display signal that instructs the display of the customization screen to the user operation unit 8.

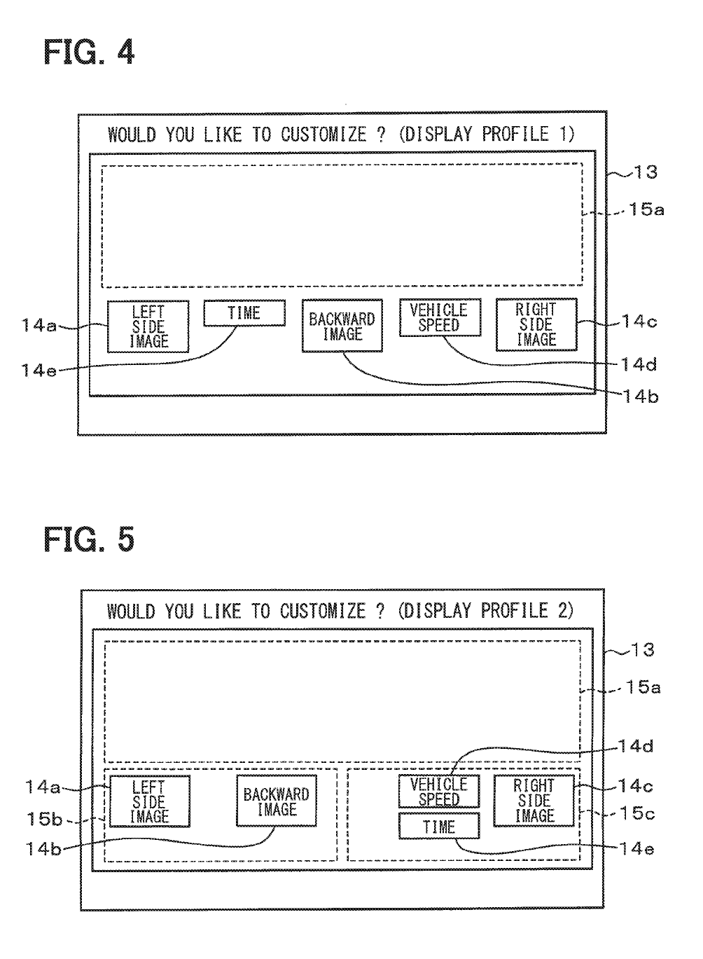

When the screen-display signal that instructs the display of the customization screen is received from the electronic control device 1, the user operation unit 8 displays a customization screen 13 of driver-selected display profile, as shown in FIGS. 4 and 5.

That is, when the user operation unit 8 detects a driver's selection of the display profile 1, the user operation unit 8 displays a customization screen 13 of the display profile 1, and when detecting a driver's selection of the display profile 2, the user operation unit displays a customization screen 13 of the display profile 2.

As shown in FIG. 4, in the customization screen 13 for the display profile 1, an icon 14a of the left side image, an icon 14b of the rearview image, an icon 14c of the right side image, an icon 14d of a vehicle speed image showing the vehicle speed, and a time image icon 14e showing the current time of the day are displayed in an area on the lower part or lower half of the windshield. That is, in a driver's view, the icon 14a of the left side image, the icon 14e of the time image, the icon 14b of the rearview image, the icon 14d of the vehicle speed image, and the icon 14c of the right side image are arranged and displayed in order from the left to the right.

In the upper part or upper half of the windshield, a display prohibition area is set and displayed, as a frame 15a. The frame 15a may be invisible to the driver. That is, the display prohibition area may not be displayed for the driver to see.

In the customization screen 13 of the display profile 2, shown in FIG. 5, just like the customization screen 13 of the display profile 1, the icons 14a-14e of those images are arranged in order and displayed in the area corresponding to the lower part of the front window, together with the frame 15a representing the display prohibition area. That is, in a driver's view, the icon 14a of the left side image, the icon 14b of the rearview image, the icon 14d of the vehicle speed image, the icon 14e of the time image, and the icon 14c of the right side image are arranged and displayed in order from the left to the right.

In addition, the lower left half area (i.e., a lower left portion) of the windshield is set as a display permission area for the left side image, and such a display permission area is represented by (i.e., displayed as) a frame 15b. The lower right half area (i.e., a lower right portion) of the windshield is set as a display permission area for the right side image, and such a display permission area is represented by (i.e., displayed as) a frame 15c. The frames 15a-15c may not be displayed either, and the display prohibition area and the display permission area may be invisible to the driver. In other words, as described above, the left side image and the right side image may be preset vehicle information, where restrictions may apply to the preset vehicle information. For example, when the left side image is preset vehicle information, the display permission area for the left side image may be the lower left half area shown in FIG. 5.

When the customization screen 13 is being displayed on the user operation unit 8, the driver can customize the display position of the image on the windshield by moving/adjusting the display position of the icons 14a-14e on the screen 13. When the driver performs a drag operation on one of those icons 14a-14e to move the display position, the user operation unit 8 transmits the operation detection signal indicative of the display position of the dragged/moved icon to the electronic control device 1.

The microcomputer 9 has a display controller 9a, a restriction provider 9b, and a notification controller 9c.

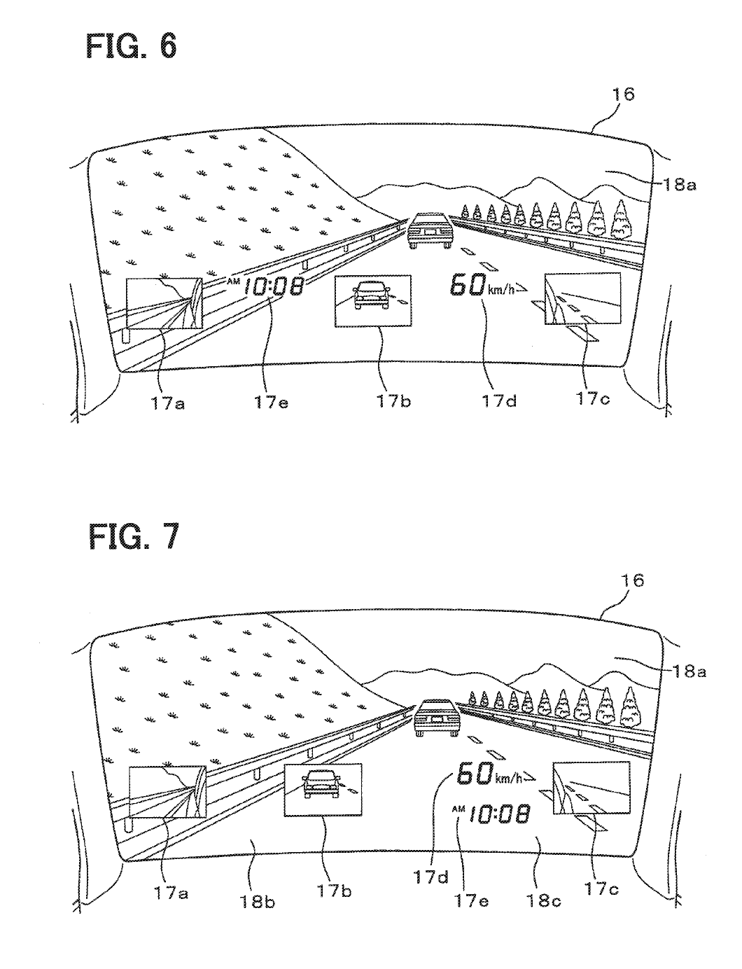

The display controller 9a outputs a display instruction signal to the display device 2 and controls display of the image on the display device 2. The display controller 9a displays images when the driver first selects a display profile but has not yet moved the display position of any of the icons 14a-14e on the customization screen 13. That is, the driver has not customized the arrangement of the icons 14a-14e on the customization screen 13 in order from left to right. That is, as shown in FIG. 6, immediately after the driver's selection of the display profile 1, the display controller 9a displays, as arranged from left to right in the driver's view, a left side image 17a, a time image 17e, a rearview image 17b, a vehicle speed image 17d, and a right side image 17c, on a lower part of a windshield 16.

In FIG. 7, immediately after the driver's selection of the display profile 2, the display controller 9a displays, arranged from left to right relative to the driver's view, the left side image 17a, the rearview image 17b, the vehicle speed image 17d with the time image 17e, and the right side image 17c on the lower part of the windshield 16. In such state, the driver can visually recognize or can perceive each of those images 17a-17e by moving his/her sightline horizontally. Further, since each of those images 17a-17e is not displayed in a display prohibition area 18a, the driver's view of the front field of the vehicle will not be obstructed by those images 17a-17e, thereby allowing the driver to appropriately recognize a situation in front of the vehicle. The display position and the size of each of the icons 14a-14e on the customization screen 13 and those of each of the images 17a-17e on the front window 16 are approximately proportional to each other.

As used herein, the images associated with each of 17a-17e may each be referred to as “vehicle information” and vehicle information can be used to refer individually and collectively to the images 17a-17e.

The restriction provider 9b may restriction the display position of the image that can be customized by the driver. That is, when the driver performs a drag operation of an icon on the customization screen 13 to move the display position as mentioned above, the restriction provider 9b determines whether the display position while moving the icon or the display position after the moving the icon conforms to the display profile's conditions described above.

More practically, the condition conformity determination may be made as described in the following. When the display profile 1 is being selected, the restriction provider 9b calculates and compares the coordinate range of the icon 14a of the left side image, the coordinate range of the icon 14b of the rearview image, and the coordinate range of the icon 14c of the right side image with each other. In such manner, the restriction provider 9b determines whether condition (a) is satisfied. By calculating and comparing the coordinate ranges of all the icons 14a-14e with the coordinate range of the frame 15a of the display prohibition area, the restriction provider 9b determines whether condition (b) is satisfied. When both conditions (a) and (b) are satisfied, the restriction provider 9b determines that the display profile 1's condition(s) are satisfied. When at least one of the conditions (a) and (b) is not satisfied, it is determined that display profile 1's conditions are not satisfied.

When the display profile 2 is selected, the restriction provider 9b calculates and compares the coordinate range of the icon 14a of the left side image with the coordinate range of the frame 15b of the display permission area, to determine whether the condition (c) is satisfied. The restriction provider 9b then calculates and compares the coordinate range of the icon 14c of the right side image with the coordinate range of the frame 15c of the display permission area, to determine whether the condition (d) is satisfied. The restriction provider 9b further calculates and compares the coordinate ranges of all the icons 14a-14e with the coordinate range of the frame 15a of the display prohibition area, for determining whether the condition (e) is satisfied. When the restriction provider 9b determines that all of the conditions (c) to (e) are satisfied, the restriction provider 9b determines that display profile 2's conditions are satisfied. When at least one of the conditions (c) to (e) is not satisfied, the restriction provider 9b determines that the display profile 2's conditions are not satisfied. Note that the restriction provider 9b may perform a coordinate range calculation for the icons by using any method, such as coordinate calculation of diagonally-opposite two points or the like.

When the restriction provider 9b determines that the display position of the icon during the move or after the move satisfies a display profile's condition, the restriction provider 9b permits the display of the image at a position on the windshield 16 corresponding to the display position of the icon during the move or after the move. On the other hand, when the restriction provider 9b determines that the display position of the icon during the move or after the move does not satisfies a display profile's condition, the restriction provider 9b prohibits the display of the image at a position on the windshield 16 corresponding to the display position of the icon during the move or after the move. In such manner, i.e., by prohibiting the display of the image at a certain position on the windshield 16, the restriction provider 9b restricts the display position of vehicle information on the customizable display.

When a restriction is put on the customizable image display position, the notification controller 9c transmits a notification signal to the user operation unit 8, and notifies the driver that an image, i.e., vehicle information, cannot be displayed at the corresponding position on the windshield 16 that corresponds to the position of the icon on the customization screen 13.

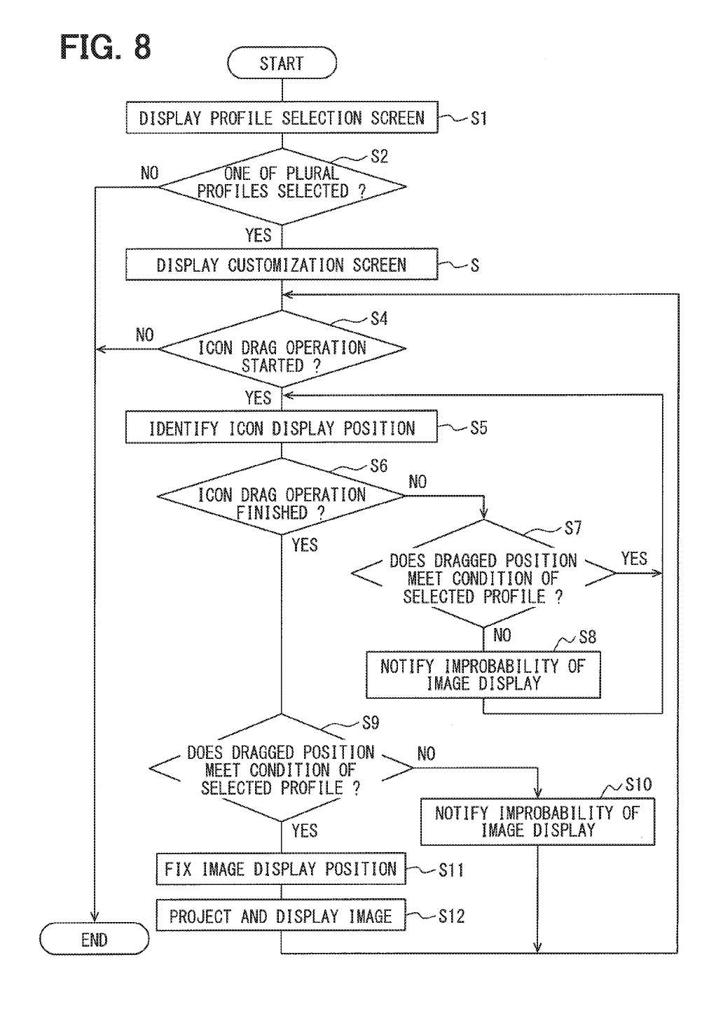

The effects of the above configuration are described with reference to FIG. 8 to FIG. 15.

With reference to FIG. 8, the microcomputer 9 in the electronic control device 1 starts to perform a display position change process, when the display condition of the profile selection screen 11 is satisfied, and transmits the screen-display signal, which instructs display of the profile selection screen 11, to the user operation unit 8. At S1, the profile selection screen 11 is displayed on the user operation unit 8. At S2, when the microcomputer 9 displays the profile selection screen 11 on the user operation unit 8, it is determined whether the driver has selected one of the display profiles. When the microcomputer 9 determines that a predetermined time has passed without selection of any display profile by the driver, a negative determination is made, i.e., NO, and it is determined that a processing end condition is satisfied and the microcomputer 9 ends the display position change process.

On the other hand, at S2, when the microcomputer 9 determines that the operation detection signal is received from the user operation unit 8 and the driver has selected one of the display profiles based on the received operation detection signal, a positive determination is made, i.e., YES. The microcomputer 9 transmits the screen-display signal that instructs a customization screen 13 corresponding to a display profile selection by the driver to the user operation unit 8. At S3, the user operation unit 8 displays the customization screen 13. At S4, when the microcomputer 9 displays the customization screen 13 on the user operation unit 8, it is determined whether the driver has started a drag operation of an icon. When the microcomputer 9 determines that a predetermined time has passed without recognizing a start of the drag operation of an icon (i.e., movement of the icon) by the driver, a negative determination is made, i.e., NO, the processing end condition is satisfied, and the microcomputer 9 ends the display position change process.

The microcomputer 9, upon receiving an operation detection signal from the user operation unit 8 and determining that the driver has started a drag operation, a positive determination is made, i.e., YES, and the process proceeds to 65. At S5, the display position of the icon corresponding to the drag operation is identified. At S6, it is determined whether the driver has ended the drag operation of the icon. If the drag operation of the icon is not finished, i.e., NO, the process moves to S7 and it is determined whether the identified display position satisfies/meets the display profile's condition. When the microcomputer 9 determines that the identified display position of the icon being moved according to the drag operation does not satisfy the display profile's condition, a negative determination is made, i.e., NO, the microcomputer 9 transmits the notification signal to the user operation unit 8. At S8, the microcomputer 9 notifies the driver that an image cannot be displayed at the position on the windshield 16 corresponding to the display position of the icon at S8, and the process returns to 65. The processes at S6 and 67 are repeated.

When the microcomputer 9 determines that the driver has ended the drag operation, a positive determination is made, i.e., YES, and the process proceeds to 69. At S9, it is determined whether the last-identified display position satisfies the display profile's condition. When the microcomputer 9 determines that the last-identified display position, that is, the display position of the icon after the drag operation, does not satisfy the display profile's condition, a negative determination is made, i.e., NO, and the process proceeds to S10. At S10, the microcomputer 9 transmits the notification signal to the user operation unit 8, and notifies the driver that an image cannot be displayed at the position on the windshield 16 corresponding to the display position of the icon. After S10, the process returns to S4 and the subsequent processes described above may be repeated.

On the other hand, when the microcomputer 9 determines that the display position of the icon after the move based on the drag operation satisfies the display profile's condition, a positive determination is made, i.e., YES, and the process proceeds to S11. At 811, the microcomputer 9 fixes or establishes, as the display position of the image, the position on the windshield 16 corresponding to the display position of the icon after the move. At S12, the microcomputer 9 outputs a display instruction signal to the display device 2, projects and displays the image on the windshield 16, and returns to 84 to repeat the subsequent processes.

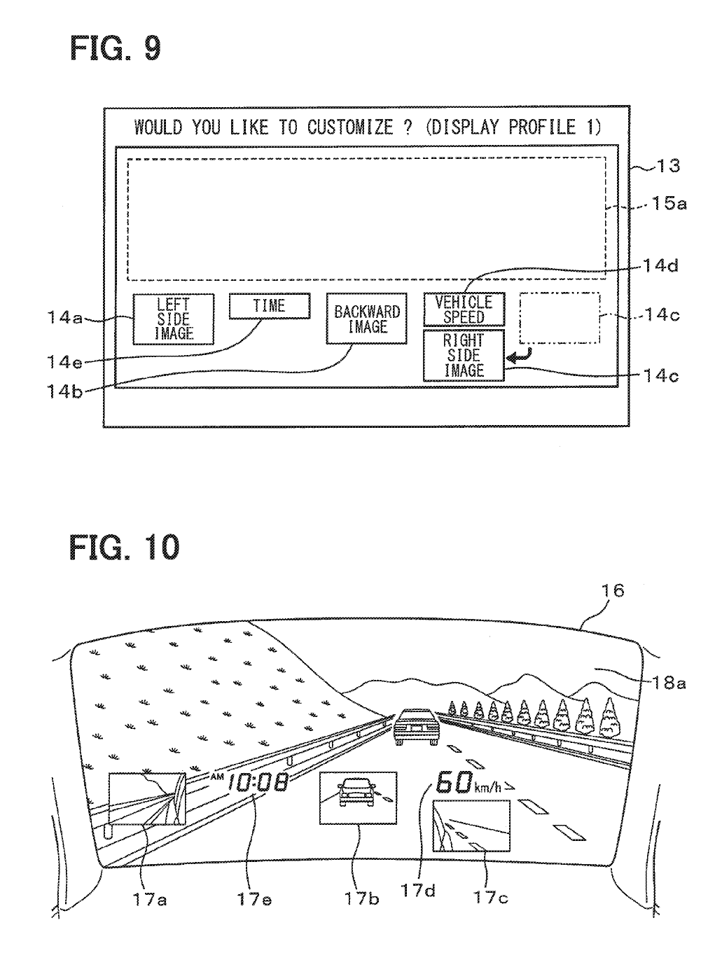

By performing the above-mentioned processing, for example, when the driver moves, the icon 14c of the right side image under the icon 14d of the vehicle speed image on the customization screen 13 of the display profile 1, as shown in FIG. 9, the microcomputer 9 determines that the display position of the icon after the move satisfies the display profile 1's condition. Then, the microcomputer 9 displays the right side image 17c under the vehicle speed image 17d, as shown in FIG. 10. In such a way, the driver can display the right side image 17c at a driver-desired, easy-to-view position.

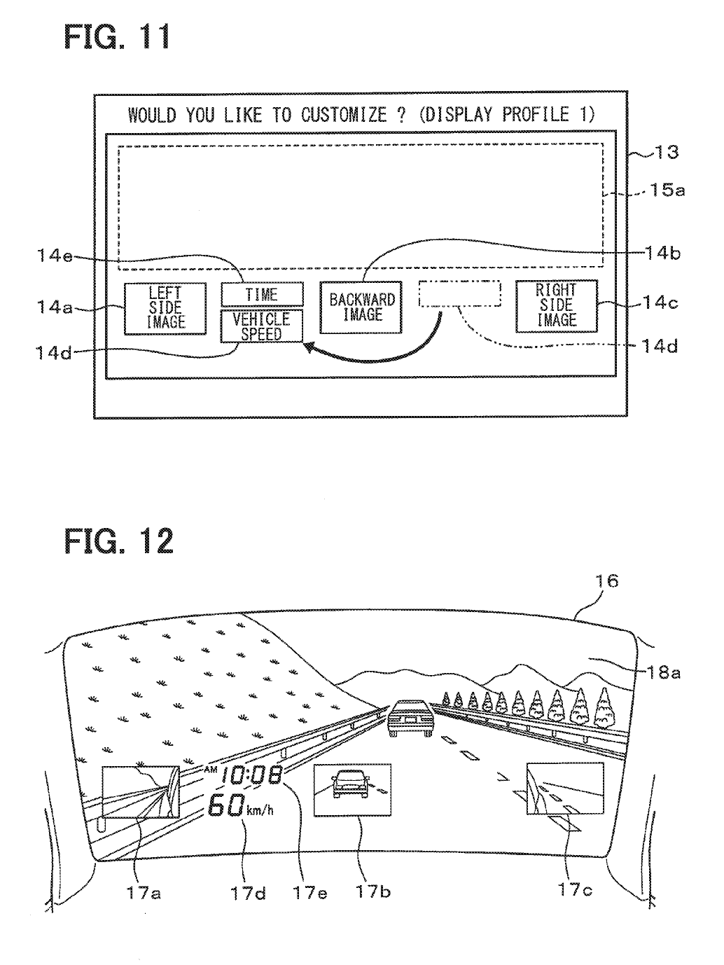

As shown in FIG. 11, for example, when the driver moves the icon 14d of the vehicle speed image to a position under the icon 14e of the time image on the customization screen 13 of the display profile 1, the microcomputer 9 determines that the display position of the icon after the move satisfies the display profile 1's condition. Then, as shown in FIG. 12, the microcomputer 9 displays the vehicle speed image 17d at a position under the time image 17e, as shown in FIG. 12. In such manner, the driver can display the vehicle speed image 17d at a driver-desired, easy-to-view position.

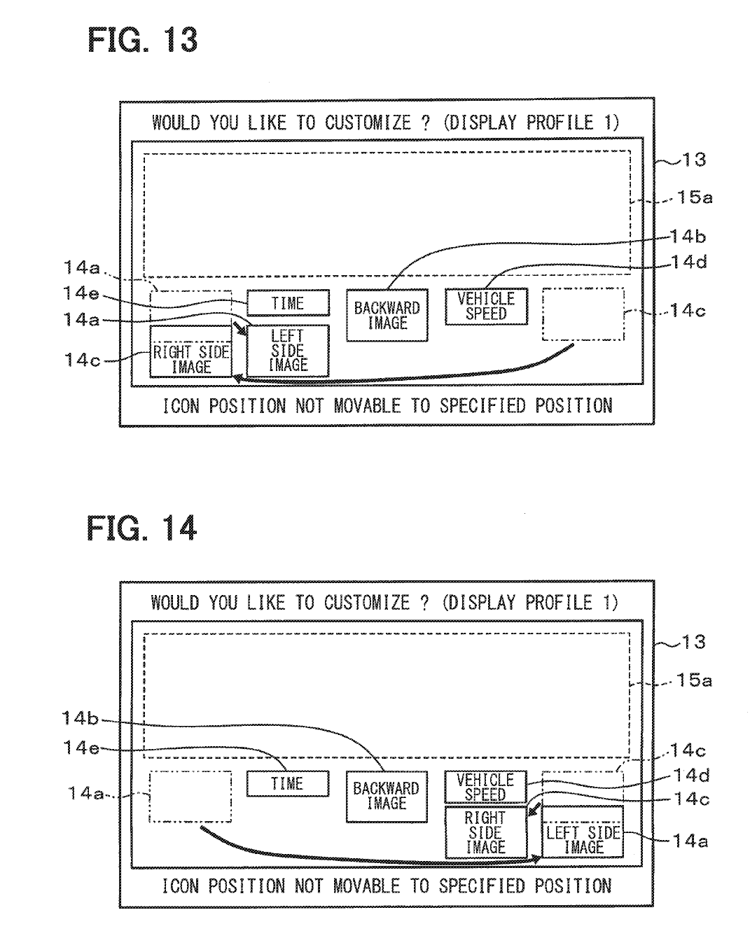

On the other hand, as shown in FIGS. 13 and 14, when the driver moves the icon 14a of the left side image to a right-hand side on the customization screen 13 of the display profile 1, and moves the icon 14c of the right side image to a left-hand side, which results in a reverse positioning of the icon 14a of the left side image and the icon 14c of the right side image, the microcomputer 9 determines that the after-the-move positions of the icons 14a and 14c do not satisfy the display profile 1's condition.

Then, the microcomputer 9 displays a message “NOT MOVABLE TO SPECIFIED POSITION”, for example, to notify that a restriction is put on the display position. In such manner, “directional” or direction-specific left side image 17a and right side image 17c are preemptively prevented from being displayed at reverse positions, thereby preventing a misperception of the images by the driver and appropriately maintaining vehicle safety.

The restriction is also applied to the move of the icon 14a of the left side image to a position on a right-hand side of the icon 14b of the rearview image, or applied to the move of the icon 14c of the right side image to a position on a left-hand side of the icon 14b of the rearview image on the customization screen 13 of the display profile 1.

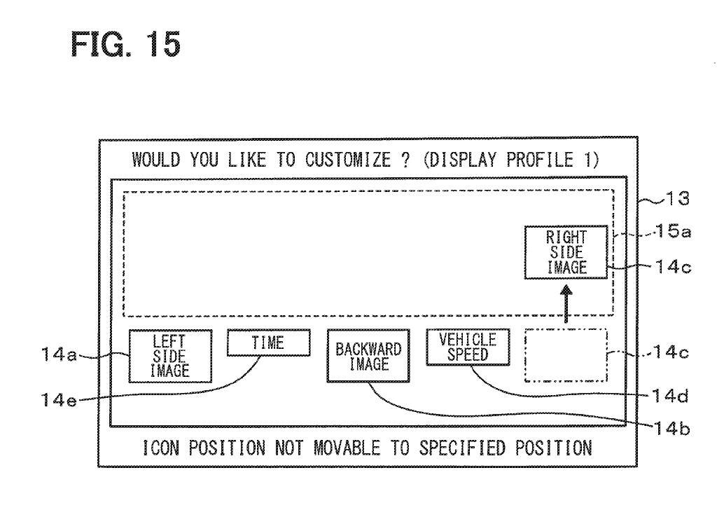

As shown in FIG. 15, when the driver moves the icon 14c of the right side image, for example, to a position inside of the frame 15a of the display prohibition area on the customization screen 13 of the display profile 1, the microcomputer 9 also determines in such case that the display position of the icon after the move does not satisfy the display profile Is condition. The microcomputer 9 then displays the message “NOT MOVABLE TO SPECIFIED POSITION”, and provides a notification that a restriction has been applied to the driver's desired display position of icon 14c and the corresponding vehicle information/image. In such manner, display of the right side image 17c in the display prohibition area 18a is preemptively prevented, thereby allowing the driver to appropriately perceive the front field of the vehicle without any obstruction by the images/vehicle information. The restriction is also applied in the same manner when the driver moves the icons other than the icon 14c of the right side image into the frame 15a of the display prohibition area. The above description describes an example of the customization screen 13 for display profile 1, and a similar operation may be performed when the customization screen 13 of the display profile 2 is displayed.

The following effects may be achieved by the embodiments described herein.

In the electronic control device 1, a restriction is put on the display position of the image that can be customized by the driver. Restrictions are not applied on the display positions of the “non-directional” images, such as the vehicle speed image 17d, the time image 17e, and the like, thereby allowing the display position of those images to be movable to a driver-desired, easy-to-view position.

On the other hand, restrictions are applied on the display position of those “directional” images/information such as the left side image 17a and the right side image 17c, which could possibly be misperceived by the driver if the display positions of the images/information were to be reversed, thereby preemptively preventing the misperception. That is, the applied restrictions allow for both of an improved viewability of display information in a driver-desired, easy-to-view position and prevent possible misperceptions by the driver to maintain vehicle safety.

In the display profile 2, restriction is put on the customizable image display position customizable by the driver, by providing the display permission area 18b to the left side image 17a, and providing the display permission area 18c to the right side image 17c. In such manner, restrictions can be applied to the left side image 17a and the right side image 17c based on an absolute guidance or index, i.e., the lower left- or lower right-half area as shown in FIG. 5, not merely a relative index/guidance.

Further, in the display profile 1 and the display profile 2, restriction is put on the display position of all the images that can be customized by the driver, by providing the display prohibition area 18a to all the images 17a-17e. By setting and defining an obstruction-free area as the display prohibition area 18a where the driver's view should not be obstructed by any image/vehicle information, a driver can still customize the position of images for driver convenience while preserving a clear view of the road.

Further, when restricting the display position of the customizable image, the driver is notified that the driver's desired image position is restricted. In such manner, an inappropriate display position of the icon during the move or after the move by the drag operation is recognized by the driver, thereby prompting the user to retry or rearrange the display position for an appropriate, non-restricted customization.

The present disclosure is not necessarily limited to the above-described embodiments. That is, the other embodiments as well as modifications thereof may be included in the scope of the disclosure. Further, combinations and/or partial modifications down to only one element may also be included as well.

Although the configuration in the above-described embodiment includes a display of the rearview image, the display of the rearview image is optional if, for example, the driver is capable of viewing the rear field of the vehicle by using a rearview mirror or the like. In addition, besides displaying the vehicle speed image and the time image, other images such as an engine rotation (rpm), a fuel gauge image, a battery charge amount image, and the like, may also be displayed. As used herein, these aforementioned images may also be referred to as vehicle information. Further, the image(s)/information displayed on the windshield 16 may be arbitrarily selected by the driver.

Although the configuration described above is the one that the display position of the image on the front window 16 is customized, i.e., moved, by dragging an icon on the customization screen 13 by the driver's drag operation. That is, a drag operation of an icon is used to indirectly move the display position of the images on the front window 16 in the present disclosure. However, any method other than the drag operation of an icon may be usable for the customization of the display position of the images.

For example, a touch panel function may be provided for at least an image display area of the windshield 16, and the driver may perform a drag operation of the displayed image directly on the windshield 16, which may be more direct than the drag operation of the icons. That is, the display position of the images may be directly moved by the driver. Further, the display position of the images may be specified by numbers, or other means.

The configuration of the present disclosure includes a notification of non-satisfaction of the display position condition (i.e., a driver is notified of a restriction) by a display of message during or after the drag operation of the icon based on the display profile's condition. Such a message may be vocally output, visually output, or a combination of both. In addition, a warning or indication of the restriction may include other sensory cues such as a bell or chime, or a tactile feedback such as a vibration, to alert the driver of such restriction.

The configuration of the present disclosure describes the arrangement of icons and their corresponding images only on the basis of horizontal coordinates, i.e. a horizontal arrangement. However, vertical coordinates may also be defined and used to arrange the icons and their corresponding images. For example, when a forward looking camera capturing/streaming the front field of the vehicle is connected to the vehicle system, the windshield may be defined as having a vertical coordinate axis, which may define a negative direction as moving toward the bottom, lower direction of the windshield 16 (i.e., toward the hood of the vehicle) and a positive direction as moving toward the top, upper direction of the windshield 16 (i.e., toward the roof of the vehicle). Based on such vertical axis, the following condition may further be defined.

Vertical coordinate of the rearview image<Vertical coordinate of the forward looking image.

In other words, the vertical coordinate of the rearview image is less than the vertical coordinate of the forward looking image.

In such manner, in addition to preemptively preventing a misperception caused by reversing the display positions of images captured by the left and right cameras of the vehicle, further misperceptions related to the display positions of images/vehicle information corresponding to the front and rear cameras may also be preemptively prevented.

The configuration of the present disclosure includes a satisfaction determination that determines whether a display profile's condition during the move/drag of the icon on the screen has been satisfied. That is, whether or not the display position of the icon satisfies the display profile's condition is determined before the drag operation by the driver is completed. However, such a determination may be made only after the completion of the drag operation by omitting the processes at S7 and S8.

The customization of the image display position may be not only performed by the driver, but may also be performed, for example, by a worker in a manufacturing facility during vehicle manufacture, by a sales representative or maintenance technician at vehicle dealership, and the like.

Although the present disclosure has been fully described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by the appended claims.

What is claimed is:

1. An electronic control device comprising:
a display controller configured to control a display device to display vehicle information; and
a restriction provider configured to apply a restriction on a display position of the vehicle information, the display position of the vehicle information is customizable, wherein
the vehicle information includes a vehicle environment image captured at least by an on-board camera.

2. The electronic control device of claim 1, wherein
the restriction provider applies the restriction to directional vehicle information.

3. The electronic control device of claim 1, wherein
the restriction provider applies the restriction by setting a display permission area for preset vehicle information.

4. The electronic control device of claim 1, wherein
the restriction provider applies the restriction by setting a display prohibition area for all vehicle information.

5. The electronic control device of claim 1 further comprising:
a notification controller configured to provide a notification that the restriction has been applied to the display position of the vehicle information.
